(19) United States
(12) Patent Application Publication
(10) Pub. No.: US 2006/0284954 A1
(43) Pub. Date: Dec. 21, 2006

(54) Chitosan and use thereof as color-fixing agent in ink jet recording materials

(75) Inventors: Michael Ahlers, Eberbach (DE); Berthold Kohler, Neckargemund (DE)

Correspondence Address: LEYDIG VOIT & MAYER, LTD, 700 THIRTEENTH ST. NW, SUITE 300, WASHINGTON, DC, 20005-3960, US

(73) Assignee: GELITA AG, Eberbach (DE)

(21) Appl. No.: 11/455,750

(22) Filed: Jun. 20, 2006

Related U.S. Application Data
(63) Continuation-in-part of application No. PCT/EP04/14258, filed on Dec. 15, 2004.

(30) Foreign Application Priority Data
Dec. 22, 2003 (DE) 103 61 247.5

(51) Int. Cl. B41J 2/01

(52) U.S. Cl. 347/105

(57) ABSTRACT

To provide an ink jet recording material wherein, in particular, the problem of light fastness of the prints, i.e., the oxidative decomposition of the organic dyes in the inks, is eliminated, the use of chitosan or a derivative thereof is proposed as color-fixing agent in a color-receiving layer of ink jet recording materials.

### CROSS-REFERENCE TO RELATED APPLICATIONS

This patent application is a continuation-in-part application of International Application No. PCT/EP2004/014258, filed Dec. 15, 2004, which claims the priority of German Patent Application No. 103 61 247.5, filed Dec. 22, 2003, which are each incorporated by reference.

### BACKGROUND OF THE INVENTION

The invention relates to a novel use of chitosan or a derivative thereof as color-fixing agent in a substantially filler-free color-receiving layer of ink jet recording materials and to ink jet recording materials with a sheet-like support and a color-receiving layer.

The invention further relates to a method for producing such recording materials.

The market for ink jet applications, particularly in the high-quality market sector of so-called photo glossy papers, is developing very rapidly. Owing to the rapidly growing number of digital cameras sold, there is also a significant increase in the demand for photo paper that can be printed with ink jet printers in the SOHO (small office/home office) sector.

The search for an optimum paper coating for high-quality image reproductions resulted in various proposals, and reference is made to EP 0 847 868 as only one example thereof.

There still remains the problem of coordination with the printer technologies and the related ink formulation and with the paper as color-receiving or color-receptive layer. The various paper coating concepts that presently exist alongside one another resolve the problems that arise to a varying degree and with a different focus.

In a variant of the currently available paper coatings, use is made of porous materials (pigments) with a reasonably priced binder as paper coating. Porous silica particles, in some cases even nano particles, or other highly porous materials are used here as pigments. Nonionic polymers such as, for example, polyvinyl alcohol, are often used as binder. These papers are characterized by rapid drying times of the inks. However, on the other hand, the colors are often pale and the surface gloss is low. Aside from that, the insusceptibility of these papers to aging, particularly owing to the lack of light fastness of the ink jet dyes, is not very pronounced.

The oxidation of the organic dyes is highly accelerated by atmospheric oxygen, in particular, owing to the large surfaces of the porous materials. Furthermore, it is assumed that the cationic substances used as color-fixing agent also contribute towards accelerating the oxidation. PolyDAMAC, which contains quaternary amine functions, is often resorted to. On the other hand, cationic color-fixing agents are necessary for color-fixing the often anionic, organic dyes in the inks, so as to prevent these from being easily wiped off the paper or from migrating in the paper. This applies quite particularly since silica-containing coatings exhibit a rather anionic character. The problem of frequent lack of light fastness is described, for example, in Katri Vikman, Journal of Imaging Science and Technology (2003) 47, 30-37.

As an alternative to the aforementioned coatings with porous materials, gelatin is used as coating. Gelatin belongs to the film-forming substances with swelling capability, with which coatings can be made with ease. Upon contacting aqueous inks, the gelatin film swells by a multiple and can thus absorb large quantities of water. After penetration, the dyes are located high up in the layer, so that high color densities are obtainable. With the use of gelatin, a very homogenous film, i.e., a very homogenous coating, is also obtained, which results in high gloss values. In particular, gelatin-coated papers are suitable for the photo glossy applications mentioned at the outset, with which a high light fastness of the prints is then achieved owing to the gelatin coating. This is attributed to the fact that the gelatin forms a closed film over the dyes and prevents contact with the atmospheric oxygen. As gelatin is a polyelectrolyte, the gelatin itself contributes to a greater or lesser degree (depending on the method of production) to the color-fixing of anionic dyes. However, this color-fixing effect is, as a rule, insufficient to obtain satisfactory color-fixing.

Cationic color-fixing agents can also be used in gelatin coatings. However, in addition to influences on the image quality and the drying time of the inks, in particular, traditionally known fixing agents (e.g. PolyDADMAC) are detrimental to the light fastness of prints on gelatin-coated papers. Therefore, in general, the rule applied that an improvement in the color-fixing had, at the same time, the adverse effect of impairing the light fastness of the prints.

### BRIEF SUMMARY OF THE INVENTION

The object of the invention is to propose an ink jet recording material based on gelatin, in which, in particular, the problem of the light fastness of the prints, i.e., the oxidative decomposition of the organic dyes in the inks is eliminated.

This object is accomplished, in accordance with the invention, with an ink jet recording material having a sheet-like support and a color-receiving layer, in that the color-receiving layer is produced on the basis of gelatin and includes a component of chitosan and/or a derivative thereof as color-fixing agent, and the color-receiving layer is substantially filler-free.

The glossy papers according to the invention, surprisingly, exhibit, in addition to an invariably good drying speed, an excellent color-fixing and a very good light fastness for the ink jet dyes. The recording materials obtained, therefore, attain the standard of high-end glossy papers.

Surprisingly, chitosan and/or chitosan derivatives can be used as color-fixing agent in the matrix, produced on the basis of gelatin, of the color-receiving layer without noticeably impairing the light fastness of the dyes, although, owing to the successes described in the literature, polycationic systems (e.g. also PolyDADMAC) are generally rated as being detrimental to the light fastness.

Accordingly, in general, the subject matter of the present invention is the use of chitosan or a derivative thereof as color-fixing agent in a color-receiving layer of ink jet recording materials, which is substantially filler-free.

Chitosan itself is a modified natural product and is based on the natural product chitin. Following a deacetylation reaction, a large number of free amino groups having a distinctly cationic character at low pH values are present therein.

Chitosan has already been described in conjunction with the production of ink jet recording material (cf., e.g., EP 0 847 868 mentioned at the outset) but not as component of the color-receptive or color-receiving layer therein.

JP 05-169789 A recommends a color-receiving layer for recording materials, which, in addition to a cationic pigment (filler), contains chitosan or a chitosan salt, and the color-receiving layer may contain gelatin as binder.

The recording materials do exhibit an improved color-fixing in comparison with pure gelatin recording materials, but, as in all porous materials, the color fastness of the ink jet dyes diminishes significantly. Furthermore, these recording materials cannot be classified as high-end glossy products.

In EP 0 764 546 A1, it is proposed to provide a recording material with an ink-receiving layer consisting of a pigment and a carboxyl group modified gelatin. Here, again, an improvement in the ink absorbability is obtained in comparison with pure gelatin, but the light fastness of the ink jet dyes suffers.

The same also applies in a similar way to the recording materials described in U.S. Pat. No. 5,165,973. Herein it is recommended to use, in addition to anhydrous silica in ultra-fine form (filler), a polycationic polymer, inter alia, the chitosan derivative methyl glycol chitosan for the color-receiving layer.

### DETAILED DESCRIPTION OF THE INVENTION

It has now, surprisingly, been found that the use of chitosan as color-fixing agent does, on the one hand, exert a very good color-fixing effect on the organic dyes of the ink jet inks normally used, and, on the other hand, does not negatively influence the light fastness of the organic colors in the ink jet inks. It is, however, important that substantially no amounts of filler should be contained in the color-receiving layer.

Hereinbelow the term chitosan is used to represent chitosan products themselves or derivatives thereof.

Chitosan itself is preferably used with a deacetylation degree of more than 50%, in particular, more than 70%. Particularly good results are obtained with chitosan qualities whose deacetylation degree lies in the range of from 75 to 97%.

The chitosan derivatives which are also usable in accordance with the invention, for example, chitosan with modified amino functions, are derived from the above-described chitosan qualities. The modified amino functions can be converted, for example, with bifunctional cross-linking agents into cross-linked chitosan derivatives.

Typical, advantageous modifications of the amino functions (amino groups) of the chitosan polymer include acylation, tosylation, alkylation, carboxylation, sulfation, Schiff base formation as well as quaternary salt formation.

The quaternary salt formation is of special interest since it allows to provide permanent cationically charged moieties on the polymer, which are available independent of the pH of the environment. The cationic moieties may serve various purposes, inter alia to increase the solubility of the polymer.

The modifications of the amino functions of the chitosan polymer mentioned above are described in detail in Keisuke Kurita, Chitin and Chitosan Derivatives published in Desk Reference of Functional Polymers (1997), pages 239 to 259, American Chemical Society, Washington D.C. which is incorporated herein by reference.

Further advantageous modifications of the chitosan polymer may be obtained by graft copolymerization. Details of this technology are set out by M. J. Zohuriaan-Mehr in Advances in Chitin and Chitosan Modification through Graft Copolymerization, Iranian Polymer Journal (2005), 14 (3), pages 235 to 265, Iranian Polymer and Petrochemical Institute, which is incorporated herein by reference.

The amount of chitosan in the area of the color-receiving layer near the surface is preferably up to 20 wt. %. Higher amounts are, in principal, possible, but then the color-fixing property of the coating does not increase to any more substantial a degree. Nor is any influence on the light fastness of the ink jet colors to be noted with amounts larger than 20 wt. % in the color-receiving layer. On the other hand, the image quality (e.g. marginal sharpness of the print points and the uniformity of color areas) decreases and the drying time increases with higher amounts of chitosan.

In view of the cost factor caused by the chitosan component in the coating, this component will preferably be up to 10 wt. %. Significant effects are already achieved with amounts of chitosan or amounts of its derivatives in the order of magnitude of 1 wt. %.

The production of the color-receiving layer on the basis of gelatin results in the advantages of gelatin coatings mentioned at the outset, in addition to the high color-fixing effect of the chitosan. The recording material also profits from the good water absorbability of the gelatin.

The gelatin qualities that are preferably to be used in accordance with the invention are, in particular, low-bloom gelatin, in particular, bone gelatin and/or gelatin modified with succinic anhydride.

In view of the fact that chitosan is insoluble in neutral water, pH values of the aqueous medium of ≦5 must be worked with.

The color-receiving layer of the recording materials according to the invention is preferably applied with a weight per unit area of 5 to 20 g/m² to the supporting layer. In particular, weights per unit area of the color-receiving layer ranging from 10 to 15 g/m² are suitable.

The previously discussed components of the color-receiving layer of the recording material according to the invention may be supplemented by UV absorbers, surfactants and the like.

Fillers, including inorganic pigments, which, in the literature, are often used in color-receiving layers, are: kaolin, Ca— or Ba-carbonates, silicon dioxide, titanium dioxide, bentonite, zeolite, aluminium silicate, calcium silicate, or colloidal silicon dioxide, as well as inert organic particles such as, for example, plastic globules.

Examples of inorganic pigments are: aluminium oxide or aluminium hydroxide, aluminium oxide hydrate, porous silica, colloidal silica and mixtures thereof, barium sulfate, titanium oxide and boehmite (cf., e.g., EP 1 226 959 A2) as well as bentonite and calcium carbonate.

Of these fillers/pigments, small amounts, at most, i.e., at most up to 4 wt. %, preferably, at most, 2 wt. % should be present in the color-receiving layer according to the invention so as not to impair the light fastness of the ink jet dyes to too great an extent. Color-receiving layers which are free from fillers and pigments are best.

Suitable UV absorbers are, e.g., benzotriazoles, benzophenones, thiazolidones, oxazoles and thiazoles (cf., e.g., EP 1 00 767 A1).

The following compounds are, for example, used as surfactants: nonionic fluorinated alkyl esters, Zonyl® fluorochemicals (DuPont Corp.), polysiloxanes, polyoxyethylene-lauryl ethers and other poly(oxyethylene-co-oxypropylenes), polyoxyethylene and ionic surfactants such as, for example, Dowfax® (alkyl diphenyl oxide disulfonic acids of Dow Chemicals) or Alkonol® (sodium alkyl naphthalene sulfonates of DuPont Corp.), as recommended, for example, in EP 1 211 089 A2.

The invention further relates to a method for producing a color-receiving layer for the ink jet printing process on a recording material, wherein a coating composition, comprising chitosan and/or a derivative thereof, gelatin and/or gelatin derivative and a solvent, is produced, applied to a sheet-like support and allowed to dry.

Papers coated with water-repellent polymers (PE, PVC) are preferably corona-treated before being coated with the color-receiving layer.

When producing the coating composition, it has again to be taken into consideration that chitosan and its derivatives are usually insoluble in water and only dissolve at a pH value of the aqueous medium of ≦5.

Accordingly, in a variant of the present method according to the invention an aqueous medium having a pH of ≦5 is preferably used as solvent, and the chitosan or its derivative dissolved therein and then mixed with the gelatin and/or gelatin derivative as polymeric film-forming medium. However, the gelatin will preferably be first allowed to swell in the chitosan/chitosan derivative solution and then heated to a higher temperature, e.g., 60° C. so as to completely dissolve the gelatin. The thus obtained coating substance is spreadable.

Alternatively, the components gelatin and chitosan can be mixed in the dry state, and an aqueous medium as solvent with a pH value of ≦5 added. Finally, the temperature is increased in order to completely redissolve the gelatin. In this way, too, a coating composition is obtained, which is spreadable.

A low-bloom gelatin, in particular, bone gelatin and/or gelatin modified with succinic anhydride, is preferably used as gelatin.

As further component of the coating composition, tensides are recommended, which improve the adhesion to the sheet-like support or already improve its wetting upon application and can also help to further improve the quality of the image print on the recording material.

Of the types of chitosan or derivatives available, low-viscosity products, which, in addition, are preferably substantially completely deacetylated, are preferably used.

The thickness of the coating on the support is variable within wide limits, and good results are often obtained with a coating having a weight per unit area (in the dry state) of 5 to 20 g/m². A preferred range is from 10 to 15 g/m².

Since the color-fixing takes place close to the surface of the color-receiving layer, it can be provided that the color-receiving layer is configured as double layer, with the lower layer preferably being formed by the same film-forming agent as used in the coating composition of the color-receiving layer with the color-fixing agent, and a coating substance then containing the chitosan and/or chitosan derivative component being applied on top of this.

In any case, it is sufficient for a chitosan and/or chitosan derivative component to be present in the proximity of the surface of the color-receiving layer in a concentration of up to 20 wt. %.

Significant effects regarding the color-fixing are already obtained with chitosan and/or chitosan derivative components of approximately 1 wt. %. Accordingly, the preferred range lies at from 1 to 10 wt. %.

These and other advantages of the invention will be explained in greater detail hereinbelow with reference to the Examples.

### EXAMPLE 1

Formulation:
15 g GELITA® Imagel MS gelatin (pig skin gelatin modified with succinic anhydride)
0.25 g TM 1220 type chitosan
84.75 g water

Preparation:

84.75 g water is added to 0.25 g chitosan (ChitoClear® TM 1220, manufacturer: Primex; deacetylation degree 97%) in a 250 ml beaker, and the mixture is adjusted to a pH of 5 by strong agitation with concentrated acetic acid. 15 g gelatin is then added. The mixture is allowed to swell for 25 minutes and then heated to 60° C. until the gelatin has dissolved. The pH value is determined. The entire mixture is degasified in an ultrasonic bath at T=60° C.

The mixture is then applied with a 120 μm wound-wire rod as wet film to conventional polyethylene-coated photo base paper (manufacturer: Felix Schoeller Holding GmbH & Co. KG) and allowed to dry for 5 minutes. A coating weight of approximately 15 g/m² is thereby obtained.

The paper is subsequently suspended for several hours at room temperature. After the drying, unevennesses caused by the clips are cut off, and the paper is cut to A 4 format.

### EXAMPLE 2

Formulation:
15 g GELITA® Imagel MS gelatin
0.5 g TM 1220 type chitosan
84.5 g water

Preparation of the mixture and coating as in Example 1.

### EXAMPLE 3

Formulation:
15 g GELITA® Imagel MS gelatin
1 g TM 1220 type chitosan
84 g water

Preparation of the mixture and coating as in Example 1.

### EXAMPLE 4

Formulation:
15 g GELITA® Imagel MS gelatin
3 g TM 1220 type chitosan
82 g water

Preparation of the mixture and coating as in Example 1.

### EXAMPLE 5

Formulation:
15 g GELITA® Imagel BP 150 gelatin (low-bloom bone gelatin)
0.25 g TM 1220 type chitosan
84.75 g water

Preparation of the mixture and coating as in Example 1.

### EXAMPLE 6

Formulation:
15 g GELITA® Imagel BP 150 gelatin
0.5 g TM 1220 type chitosan
84.5 g water

Preparation of the mixture and coating as in Example 1.

### EXAMPLE 7

Formulation:
15 g GELITA® Imagel BP 150 gelatin
1 g TM 1220 type chitosan
84 g water

Preparation of the mixture and coating as in Example 1.

### EXAMPLE 8

Formulation:
15 g GELITA® Imagel BP 150 gelatin
3 g TM 1220 type chitosan
82 g water

Preparation of the mixture and coating as in Example 1.

### EXAMPLE 9 (COMPARATIVE EXAMPLE)

Reference coating with PolyDADMAC solution, 34-40% polydiallyl dimethyl ammonium chloride in water (Certrex 340A, manufacturer: Mobil Oil AG)

Formulation:
15 g GELITA® Imagel MS gelatin
3 g PolyDADMAC solution
0.08 g surfactant solution (to improve the wetting behavior on the polyethylene paper)
83.92 g water

Preparation:
15 g GELITA® Imagel MS gelatin, 0.08 g surfactant solution, 3 g PolyDADMAC and 83.92 g water are put in a 250 ml beaker. The mixture is allowed to swell for 25 minutes and then heated to 60° C. until the gelatin has dissolved. The mixture is adjusted to pH 5 with diluted acetic acid. The entire mixture is degasified in an ultrasonic bath at T=60° C.

The coating of the polyethylene paper is carried out as in Example 1. The coating weight is approximately 15 g/m².

### EXAMPLE 10 (COMPARATIVE EXAMPLE)

Reference coating with PolyDADMAC solution

Formulation:
15 g GELITA® Imagel BP 150 gelatin
3 g PolyDADMAC
0.08 g surfactant solution (Example 9)
83.92 g water

Preparation of the mixture and coating as in Example 9.

### EXAMPLE 11 (COMPARATIVE EXAMPLE)

Reference coating without color-fixing agent

Formulation:
15 g GELITA® Imagel BP 150 gelatin
0.08 g surfactant solution (Example 9)
84.92 g water

Preparation of the mixture and coating as in Example 9.

### EXAMPLE 12 (COMPARATIVE EXAMPLE)

High-grade reference paper from EPSON:
EPSON Premium Photo Glossy Paper

### EXAMPLE 13 (COMPARATIVE EXAMPLE)

Laboratory sample with special ink jet gelatin (GELITA® Imagel MA; pig skin gelatin modified with dodecenyl succinic acid) and Pluroni PE 6200 (manufacturer: BASF) as surfactant with preservative properties proven to be good for ink jet dyes.

Formulation:
15 g GELITA® Imagel MA gelatin
0.45 g Pluronic PE 6200
84.55 g water

Preparation:
15 g GELITA® Imagel MA, 0.45 g Pluronic PE 6200 and 84.55 g water are placed in a 250 ml beaker. The mixture is allowed to swell for 25 minutes and then heated to 60° C. until the gelatin has dissolved. The mixture is adjusted to pH 8.5 with a diluted sodium hydroxide solution. The entire mixture is degasified in an ultrasonic bath at T=60° C.

The mixture is then applied with a 120 μm wound-wire rod to polyethylene paper and dried for 5 minutes at 80° C.

After the drying, the paper is cut to A 4 format.

Description of the Test Methods

Determination of the Image Quality

To determine the image quality, test images were printed on 3 different printers (HP 970 Cxi, Canon S 800 and EPSON Stylus Photo 870), which are suited for photo-like prints and are representative of various technologies and inks on the market, and were quality assessed in accordance with the following criteria:
tackiness, bleeding, beading, banding, bronzing, wicking/feathering.
   Determination of the Drying Time

The drying time was determined as the time after which no more smearing of the colors was to be observed on approximately 1 mm-thin strips on which the base colors cyan, magenta, yellow and black had been repeatedly successively printed, upon passing a moss rubber over these after the printing. The drying times were determined on printouts printed on the HP 970 Cxi.

Determination of the Color-Fixing

The combination colors green, blue and black were printed on various ink jet printers (see above) suitable for photo printing on strips of 14 mm width and 50 mm length. After 24 hours, one half of each print was dipped into water (room temperature) for 10 minutes. The prints were then dried and the changes in the color values Δ E* were determined with a Minolta calorimeter (MINOLTA CHROMAMETER CR 300).

Determination of the Light Fastness

To determine the light fastness, areas of color (40 mm×25 mm) of the four base colors cyan, magenta, yellow and black were printed out. After a drying time of 24 hours, one half of each sample was covered and irradiated with filtered xenon light in an instrument available from the company ATLAS (SUNTEST XLS+). Conditions behind 3 mm window glass were simulated by the filter. The lamp power was set at 710 W/m² on the instrument.

Since it is not possible to control the relative atmospheric humidity and the temperature in the testing area when SUNTEST XLS+ is used, only relative tests can be carried out. In other words, only the measurement results of the samples measured at the same time in the testing area can be compared with one another.

After termination of the irradiation, the changes in color Δ E* were again determined with the MINOLTA CHROMAMETER CR 300.

Test Results

Drying Times (Determined on the Basis of Printouts on HP DESKJET 970 Cxi

TABLE 1

| Example | Drying time [s] |
|---|---|
| 1 | 42 |
| 2 | 44 |
| 3 | 42 |
| 4 | 58 |
| 5 | 43 |
| 6 | 55 |
| 7 | 63 |
| 8 | 69 |
| 11 | 49 |
| 12 | immediately dry |
| 13 | 52 |

Comparison of the image quality and the drying times produced the following results:

Comparison of the image quality and the drying times showed no disturbing influence up to a concentration of approximately 10% chitosan based on the solids content of the mixture (Examples 1, 2, 3, 5, 6 and 7). In the case of higher solids contents of chitosan, and increase in beading was observed along with a lengthening of the drying time.

The drying times were not determined for Examples 9 and 10 (Comparative Examples).

Color-Fixing of the Coating

The color-fixing of the coating was determined in accordance with the previously described method. The values obtained for the papers of the various Examples are summarized in Table 2. Values for the Comparative Example 13 are not given as the coating partially becomes detached under the above-mentioned test conditions and, consequently, results that would be meaningful to measure are unobtainable.

The measured values relating to the color-fixing clearly show that the color-fixing improves as the concentration of chitosan increases.

Light Fastness

The coatings in Examples 3 and 7 show similar, mostly even better color-fixings than the Comparative Examples (10, 11, 12). Therefore, in the light test Examples 3, 9, 12 and 13 were compared in a direct comparison with one another, i.e., in one test run. The gelatin paper (Example 13) which is known to have good light fastness was included as benchmark in the test runs. The papers were printed here with a Canon printer (Canon S 800) with an original Canon ink set. The results are summarized in Table 3.

TABLE 3

| | ΔE* (cyan) | ΔE* (magenta) | ΔE* (yellow) | ΔE* (black) |
|---|---|---|---|---|
| EXAMPLE | Canon | Canon | Canon | Canon |
| 3 | 4.3 | 2.6 | 15.5 | 0.5 |
| 9 | 7.8 | 5.7 | 37.5 | 1.1 |
| 12 | 7.1 | 4.0 | 19.8 | 0.7 |
| 13 | 4.2 | 2.9 | 14.0 | 2.0 |

In a further test series, the papers of Examples 7, 10, 12 and 13, printed with base colors, were tested by direct comparison, i.e., all 4 samples were simultaneously irradiated in one test run. The results are summarized in Table 4.

TABLE 4

| | ΔE* (cyan) | ΔE* (magenta) | ΔE* (yellow) | ΔE* (black) |
|---|---|---|---|---|
| EXAMPLE | Canon | Canon | Canon | Canon |
| 7 | 3.2 | 2.4 | 13.2 | 1.0 |
| 10 | 3.2 | 6.4 | 36.8 | 2.2 |
| 12 | 5.3 | 4.1 | 13.3 | 1.4 |
| 13 | 3.7 | 3.8 | 11.0 | 1.1 |

The light test values clearly prove the substantially improved conservation of the dyes by the gelatin/chitosan coating as compared to the coatings with PolyDADMAC and gelatin and to the commercially available EPSON paper. The high light fastnesses of the colors in the case of the pure gelatin coating were almost achieved or surpassed. However, in the case of the special gelatin-coated paper of Example 13, it is not meaningful to measure the color-fixing because the coating tends to become detached under the hard testing conditions of the color-fixing test.

1. (canceled)

2. An ink jet recording material comprising a sheet-like support and a color-receiving layer, wherein the color-receiving layer includes gelatin, and a component of chitosan and/or a derivative thereof as color-fixing agent, and the color-receiving layer is substantially filler-free.

3. The recording material in accordance with claim 2, wherein the color-receiving layer has a surface and an area close to the surface, and the component of chitosan and/or its derivative in the area close to the surface of the color-receiving layer is up to 20 wt. %.

4. The recording material in accordance with claim 3, wherein the component of chitosan and/or its derivative in the area close to the surface of the color-receiving layer is from 1 to 10 wt. %.

5. The recording material in accordance with claim 2, wherein the gelatin in the color-receiving layer comprises low-bloom gelatin.

6. The recording material in accordance with claim 2, wherein the gelatin in the color-receiving layer comprises gelatin modified with succinic anhydride.

7. The recording material in accordance with claim 2, wherein the chitosan and/or its derivative are selected from one or more low-viscosity chitosan products.

8. The recording material in accordance with claim 7, wherein the chitosan product or products is or are more than 70% deacetylated.

9. The recording material in accordance with claim 2, wherein the chitosan product comprises modified amino functions.

10. The recording material in accordance with claim 2, wherein the color-receiving layer has a weight per unit area of from 5 to 20 g/m².

11. The recording material in accordance with claim 2, wherein the color-receiving layer is filler-free.

12. The recording material in accordance with claim 2, wherein the color-receiving layer includes a UV absorber.

13. The recording material in accordance with claim 2, wherein the color-receiving layer includes a surfactant.

14. A method for producing a color-receiving layer on a recording material for ink jet printing, comprising producing a coating composition, comprising chitosan and/or a derivative thereof and gelatin and/or chemically modified gelatin, with a solvent; applying the coating composition to a sheet-like support; and, allowing the coating composition to dry.

15. The method in accordance with claim 14, wherein the chitosan and/or the chitosan derivative is dissolved in an aqueous medium solvent with a pH of ≦5, and then mixed with a polymeric film-forming agent.

16. The method in accordance with claim 14, wherein the chitosan and/or derivative and gelatin and/or chemically modified gelatin are first mixed in the dry state, and an aqueous medium with a pH of ≦5 is then added as the solvent.

17. The method in accordance with claim 14, wherein the gelatin is a low-bloom gelatin.

18. The method in accordance with claim 14, wherein the gelatin is modified with succinic anhydride.

19. The method in accordance with claim 14, wherein the coating composition includes a surfactant.

20. The method in accordance with claim 14, wherein a low-viscosity chitosan and/or chitosan derivative is used as the chitosan or the chitosan derivative.

21. The method in accordance with claim 20, wherein more than 50% deacetylated chitosan or chitosan derivative is used as the chitosan.

22. The method in accordance with claim 14, wherein the chitosan or chitosan derivative comprises modified amino functions.

23. The method in accordance with claim 14, comprising applying the coating composition onto the support so as to obtain in the dry state a weight per unit area of the coating of from 5 to 20 g/m².

24. The method in accordance with claim 14, wherein the chitosan and/or chitosan derivative in the coating is ≦20 wt. %.

25. The method in accordance with claim 24, wherein the chitosan and/or chitosan derivative in the coating is from 1 to 10 wt. %.

26. The recording material according to claim 12, wherein the UV absorber is selected from the group containing benzotriazoles, benzophenones, thiazolidones, oxazoles and thiazoles.

27. The method of claim 17, wherein the low-bloom gelatin is bone gelatin.

28. The method of claim 21, wherein more than 70% deacetylated chitosan or chitosan derivative is used as the chitosan.

29. The method of claim 22, wherein the modified amino functions are selected from the group consisting of acylation, tosylation, alkylation, carboxylation, sulfation, Schiff base formationi, and quaternary salt formation.

30. The recording material of claim 9, wherein the modified amino functions are selected from the group consisting of acylation, tosylation, alkylation, carboxylation, sulfation, Schiff base formation, and quaternary salt formation.

31. The method of claim 14, wherein the chitosan or chitosan derivative is modified by graft polymerization.

32. The recording material of claim 2, wherein the chitosan or chitosan derivative is modified by graft polymerization.
